(19) United States
(12) Patent Application Publication
(10) Pub. No.: US 2005/0279062 A1
(43) Pub. Date: Dec. 22, 2005

(54) Device for cleaning gas mixtures and method for its manufacture

(76) Inventors: Bernd Reinsch, Ludwigsburg (DE); Ulrich Alkemade, Leonberg (DE); Dieter Elbe, Sachsenheim (DE); Ilona Ullmann, Korntal-Muenchingen (DE); Jörg Jockel, Gerlingen (DE); Teruo Komori, Stuttgart (DE); Lars Thuener, Stuttgart (DE); Matthias Kruse, Stuttgart (DE)

Correspondence Address: KENYON & KENYON, ONE BROADWAY, NEW YORK, NY, 10004, US

(21) Appl. No.: 11/125,609

(22) Filed: May 9, 2005

(30) Foreign Application Priority Data
May 11, 2004 (DE) 102004023066.8
Apr. 14, 2005 (DE) 102005017265.2

(51) Int. Cl. B01D 46/00

(52) U.S. Cl. 55/486

(57) ABSTRACT

A filter device and a method for cleaning gas mixtures containing particles, e.g., soot-containing exhaust gases of internal combustion engines, as well as a method for the manufacture of the filter device, are provided. The filter device has a porous surface made of a filter base material exposed to the gas mixture to be cleaned. A layer of ceramic fibers is applied onto the surface exposed to the gas mixture to be cleaned.

### FIELD OF THE INVENTION

The present invention relates to a device for cleaning gas mixtures containing particles, in particular soot-containing exhaust gases of internal combustion engines, and also relates to a method for the manufacture of the device and a method for its use.

### BACKGROUND INFORMATION

The cleaning of exhaust gases, which in particular contain carbonaceous particles, is becoming increasingly important in the automotive field. In this context, ceramic filter systems are usually used for cleaning such gas mixtures. The challenge for optimizing such systems primarily lies not in the filtration itself—many particle filters allow for a separation of more than 99 percent—but rather in the enduring and efficient use of the filter without clogging and without an associated excessive increase of the flow-through resistance across the entire filter system.

More recent filter systems include a filter element on a sintered metal basis in place of a porous ceramic base element. These filter system have the advantage of providing a significantly more homogeneous filtration behavior than conventional filter systems and can be used largely without maintenance. Nevertheless, especially in long-term operation, a clogging of the pores can occur.

The carbon deposited as soot must therefore be removed at regular intervals, e.g., in an oxidative manner. The direct oxidation of soot by oxygen occurs at a relevant scale only at temperatures above 600° C. The temperature of exhaust gases of a diesel engine, however, is normally only 150 to 350° C. For the purpose of regeneration, consequently, the exhaust gas temperature must be increased by engine-related or other types of measures. Particularly in the case of engine-related measures, this results in an increased fuel consumption and can adversely influence the service life of the internal combustion engine. Moreover, the corresponding filter systems are also damaged by the high temperatures. Hence, it is necessary to configure filter systems in such a way that the number of regeneration processes is kept as low as possible.

A ceramic filter arrangement for cleaning combustion exhaust gases is described in U.S. Pat. No. 6,669,751, in which arrangement the cleaning effect of conventional ceramic filters is improved by the fact that a multitude of individual filters is combined into a filter composite by fiber-containing sealing layers. Although in this manner the pressure loss caused by the filter element is minimized, the number of required regeneration processes is still quite high.

An object of the present invention is to provide a device for cleaning particle-containing gas mixtures, which device has a surface that is as actively filtering as possible.

### SUMMARY OF THE INVENTION

The filter device according to the present invention has a porous surface made of a filter base material, which is exposed to the gas mixture to be cleaned, and which surface is provided with a layer of ceramic fibers.

The deposited layer made of ceramic fibers increases the effective active filtering surface of the filter device and thus results in a largely homogeneous particle separation on the filter surface exposed to the gas mixture to be cleaned.

In an example embodiment, the ceramic fibers are advantageously bonded to the filter base material using a binder. This ensures that the deposited layer of ceramic fibers is bonded to the filter surface in a manner that is stable over a long period. For this purpose, the filter surface may be produced using a sintered metal as a component.

In an example embodiment, the ceramic fibers are manufactured from aluminum oxide or an aluminosilicate, optionally with the addition of zirconium dioxide. This allows for the long-term use of the filter at temperatures of up to 1400° C. and simultaneously provides a very good resistance to temperature change. The ceramic fibers are thus also resistant against local high temperatures occurring in the regeneration processes. Furthermore, the ceramic fibers have a low density and a low thermal conductivity and demonstrate flexibility and elastic behavior. The manufacture and deposition of the ceramic fibers on the filter surface may be achieved in a cost-effective manner.

A good filtering effect of the layer containing the ceramic fibers may be achieved if the ceramic fibers have an average length of 150 to 400 μm and an average diameter of 3 to 10 μm.

It is advantageous if the binder is an inorganic material containing an aluminum oxide, silicon oxide or aluminosilicate, since this allows for a particularly good bonding of the ceramic fibers to the porous filter surface.

In another example embodiment, the layer of ceramic fibers additionally has spherical particles or second ceramic fibers having a relatively small aspect ratio of 1:5 to 1:1. Within the composite of the ceramic fibers of the layer, these are used as spacers between the individual fibers and thus facilitate the setting of a desired porosity or permeability of the layer. Additionally, the filter capacity of the layer containing the ceramic fibers increases.

In an example embodiment, the spherical particles have a catalytically active substance, which is used, for example, as an oxidation catalyst, as a catalyst for lowering the soot burn-off temperature, or as a storage material for nitrogen oxides or oxygen. This significantly improves the device's capacity for regeneration.

### BRIEF DESCRIPTION OF THE DRAWINGS

FIG. 1 shows a schematic illustration of a filter device provided with a surface coating according to a first exemplary embodiment of the present invention.

FIG. 2 shows a schematic illustration of a processing step of a method for manufacturing the filter device according to the present invention.

FIG. 3 shows a microscope picture of a filter surface partially provided with a surface coating in accordance with the present invention.

FIG. 4 shows a scanning-electron-microscope picture of the surface coating deposited on a filter material in accordance with the present invention.

FIG. 5 shows a graph of the pressure loss plotted against the particle load of a conventional particle filter and a particle filter having a coating of ceramic fibers in accordance with the present invention.

FIG. 6 shows a schematic illustration of the structure of a device coated with a layer of ceramic fibers according to a second example embodiment of the present invention, the layer of ceramic fibers containing spherical particles.

### DETAILED DESCRIPTION

An example structure of a filter device according to the present invention for cleaning gas mixtures is schematically represented in FIG. 1. The filter is integrated into a system carrying a gas mixture which is charged with combustible particles. This may be the exhaust pipe of a diesel engine, for instance. Alternatively, it is also possible to arrange the filter in a bypass of the system carrying the exhaust gas.

Filter 10 depicted in FIG. 1 takes the form of a high-grade steel or sintered metal filter and has a first side 11 facing the gas mixture to be cleaned as well as a second side 12 facing the cleaned gas mixture. The gas mixture 13 loaded with particles, e.g., with soot, is fed to filter 10 on its first side 11. Filter 10 includes a housing 16, in which the actual filter structure is integrated. The filter structure includes traps or pockets 15, which are open at their end facing first side 11 for the entrance of the gas mixture loaded with particles and are closed at their end facing second side 12. At their long sides, traps 15 are bounded by walls 18 that have a porous design such that they allow for the gas mixture to pass through while retaining the particles contained in the gas mixture.

The gas mixture permeating walls 18 enters second traps or pockets 20, which are closed at their end facing first side 11 and are open at their end facing second side 12 such that the gas mixture freed of particles may escape. Housing 16 as well as walls 18 are made of a metallic material such as, for example, a sintered metal or high-grade steel. Furthermore, it is possible to construct housing 16 and walls 18 from different materials.

To increase the active filtering surface of walls 18, the latter are at least partially, or entirely, provided with a surface coating 22 made of ceramic fibers. The ceramic fibers may be made up of, for example: an aluminum oxide; an aluminum silicate (possibly with the addition of zirconium dioxide); silicon dioxide; zirconium dioxide; or oxides or mixed oxides of transition metals such as cerium, lanthanum, molybdenum or iron. The fibers have an average diameter of 3 to 10 μm, particularly of 5 μm, and an average length of 150 to 400 μm, preferably 250 μm. Such fibers are available, for example, from the company Saffil Ltd, Cheshire, WA8 0RY, United Kingdom.

The deposition of the fibers on the filter base material of walls 18 in the formation of surface coating 22 occurs in a manner such that the pore structure of the porous walls 18 is not bonded and the resulting fiber composite is distributed homogeneously across walls 18. Furthermore, the individual fibers of surface coating 22 are bonded to one another in such a way that no fibers are able to detach from the fiber composite even at high flow rates of gas mixture 13 to be cleaned. Aluminum silicates or aluminosilicates, which initially exist as liquid sol or colloidal solutions are suitable as bonding components. By a condensation step with the separation of water, these initially largely soluble or dispersed compounds form corresponding gels. An advantage of the sol-gel process lies in the fact that ceramic coatings may be produced in a simple manner.

For this purpose, first a solution of suitable hydrolyzable alcoholates of polyvalent metal ions such as, for example, titanium, silicon or aluminum is produced in water or a suitable alcohol. Then, the ceramic fibers are suspended in the solution, and the latter is applied onto the surface of walls 18 to be coated. Depending on the water content, a dispersing agent, for example in the form of a surfactant, is added to lower the surface tension. For homogenizing the suspension, the latter is subsequently dipped, e.g., for several minutes, into an ultrasonic bath. In the presence of humidity, a metal hydroxide network forms at low temperatures during the evaporation of the solvent. This network is hydrophilic and antistatic due to its numerous metal hydroxide groups. If the gel is subsequently exposed to a suitable heat treatment, then a separation of water occurs with the formation of metal oxide groups, resulting in a hard and scratch-resistant substance.

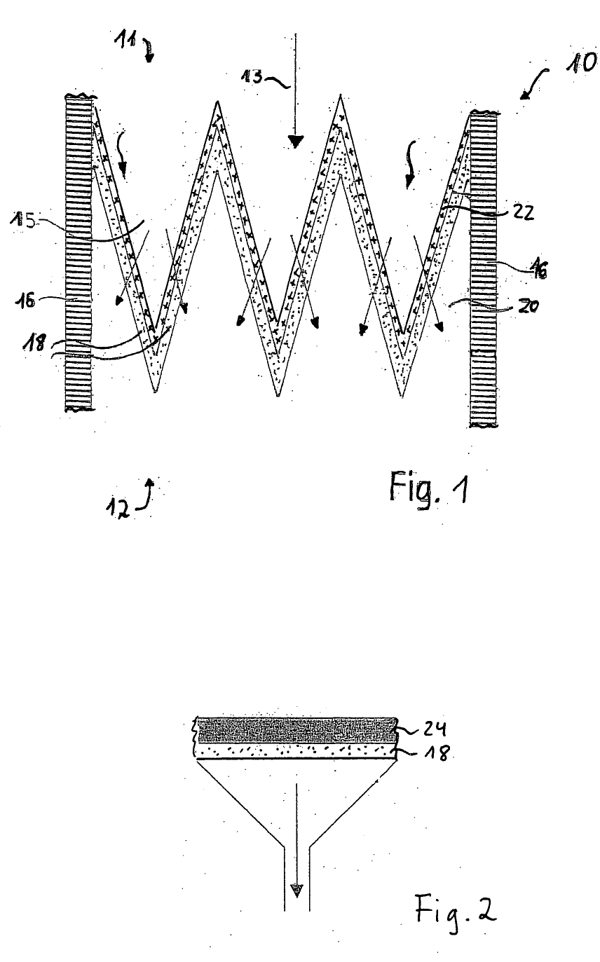

FIG. 2 shows a subsequent processing step for producing surface coating 22, in which the excess portion of deposited suspension 24 is drawn off through the pores of walls 18 using a suitable suction device at a vacuum pressure. This is followed by a heat treatment of walls 18 treated with the suspension, for example, at a temperature of 110° C., for approximately 60 minutes for initiating the sol-gel process.

Suitable suspensions for producing a surface coating 22 are manufactured, for example, using a silicon oxide sol (for example Levasil 300/30, BASF AG, Germany), or using an aluminum oxide sol (for example Resbond 795 of the company Polytec, Germany or Pural 200/D30 of the company Condea Chemie, Germany), and contain 0.1 to 10 wt. % fibers made of aluminum oxide, e.g., 0.2 to 0.9 wt. %.

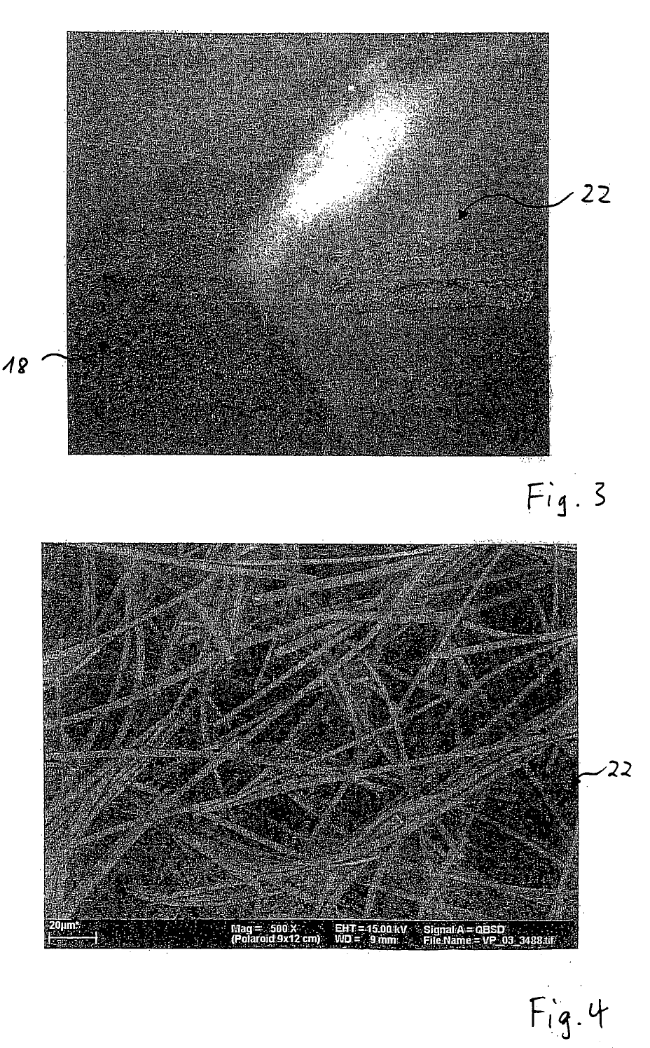

FIG. 3 shows a microscope picture, representing a magnification factor of forty, of a wall 18 which is partially provided with a surface coating 22. Here, it is possible to discern that surface coating 22 forms a homogeneous layer on wall 18. Furthermore, FIG. 4 shows a scanning electron microscope picture of surface coating 22, in which picture the mutually bonded ceramic fibers of surface coating 22 are visible.

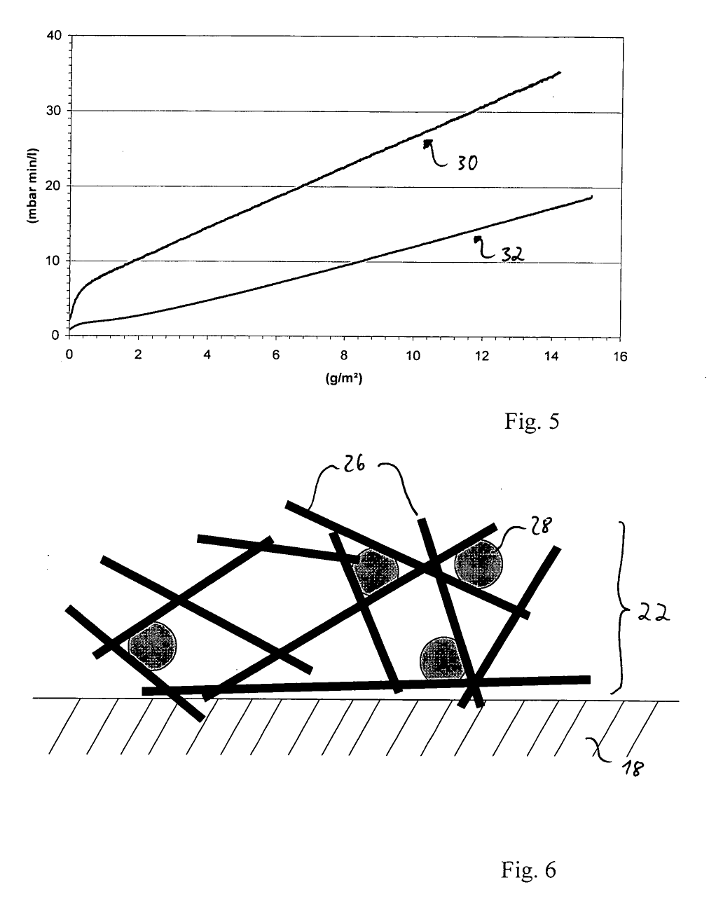

FIG. 5 shows the pressure loss of particle filters integrated in an exhaust gas flow plotted against their particle load. Plot line 30 shows the pressure loss of a conventional particle filter, and plot line 32 shows the pressure loss of a particle filter according to the present invention, the porous surface of which was provided with a surface coating 22 made of ceramic fibers. It can be clearly seen that a particle filter provided with a surface coating 22 displays a clearly lower pressure loss at an equivalent load. This means that a particle filter coated with ceramic fibers is able to handle a higher load of particles before a regeneration has to be initiated.

This effect of depth filtration may be increased further if, as depicted in FIG. 6, surface coating 22 contains spherical particles 28 in addition to ceramic fibers 26. These are used as spacers for ceramic fibers 26 and allow for the specific adjustment of the porosity or permeability of layer 22. At the same time, the addition of spherical particles 28 helps in the mechanical stabilization of surface coating 22. Spherical particles 28 may be produced from the same material as ceramic fibers 26. Alternatively, it is possible to produce the spherical particles from aluminum oxide, zirconium dioxide, titanium dioxide or from mixed oxides of transition metals. The spherical particles may have a diameter of 5 to 50 μm.

As an alternative to using spherical particles, it is also possible to add to surface coating 22 additional second ceramic fibers having a relatively low aspect ratio of 1:1 to 1:5. In this connection, aspect ratio refers to the ratio of the diameter to the length of the fiber.

Furthermore, it is possible to add catalytically active substances to the spherical particles or to the second ceramic fibers. These may be oxidation catalysts for example. Elements of the platinum group such as platinum, palladium or rhodium are suited for this purpose. Another possibility is the addition of catalytically active elements that result in lowering the soot burn-off temperature within surface coating 22 such as, for example, vanadium, cerium, iron, manganese, molybdenum, cobalt, silver, lanthanum, copper, potassium or cesium. The addition of these catalytically active substances facilitates the regeneration of the particle filter.

Another possibility for a catalytic improvement of the filter's ability to be regenerated is to use storage materials for gaseous oxidizing agents as catalytically active substances, the stored oxidizing agents resulting in a decomposition of organic components of the deposited soot. Thus, as catalytically active substances, storage materials for oxygen such as cerium oxide may be used, for example.

Moreover, by impregnating surface coating 22 with storage materials for nitrogen oxides, such as barium oxide or barium carbonate, it is possible to bind nitrogen oxides and thus to reduce the nitrogen oxides in the exhaust gas flow.

Additionally, it is also possible to provide fibers 26 with a catalytically active substance of the above-mentioned kind. In this context, fibers 26 and spherical particles 28 may contain the same or different catalytically active substances. The application of the catalytically active substances on fibers 26 or spherical particles 28 may occur before these are introduced into a suspension for producing layer 22. This allows for the application of different catalytically active materials on fibers 26 or spherical particles 28. The application may occur, for example, by impregnation. Another possibility is to produce the particles themselves from a catalytically active material. For this purpose, these may be made of a transition metal oxide or of oxides of rare earths. In this case, an impregnation with catalytically active substances may be omitted.

1. A filter device for filtering particles from exhaust gases of an internal combustion engine, comprising:
a porous filter base layer; and
a surface layer applied to the porous filter base layer,
wherein the surface layer includes at least one type of ceramic fibers, and wherein the surface layer is exposed to the exhaust gases, whereby the exhaust gases permeate through the surface layer and the porous filter base layer for filtering.

2. The device as recited in claim 1, wherein the ceramic fibers are bonded to the porous filter base layer by a binder.

3. The device as recited in claim 2, wherein the ceramic fibers include at least one of aluminum oxide, an aluminosilicate, and zirconium dioxide.

4. The device as recited in claim 3, wherein the ceramic fibers have at least one of: a) an average length of 150 to 400 μm; and b) an average diameter of 3 to 10 μm.

5. The device as recited in claim 3, wherein the surface layer further includes spherical particles.

6. The device as recited in claim 3, wherein the surface layer includes two types of ceramic fibers, and wherein one of the two types of ceramic fibers has an aspect ratio of 1:5 to 1:1, wherein the aspect ratio is defined as the ratio of the diameter of a fiber to the length of the fiber.

7. The device as recited in claim 5, wherein the spherical particles include a catalytically active substance.

8. The device as recited in claim 6, wherein at least one of the two types of ceramic fibers includes a catalytically active substance.

9. The device as recited in claim 7, wherein the catalytically active substance is an oxidation catalyst.

10. The device as recited in claim 7, wherein the catalytically active substance is a catalyst that lowers a soot burn-off temperature.

11. The device as recited in claim 7, wherein the catalytically active substance is a material storing at least one of nitrogen oxides and oxygen.

12. The device as recited in claim 8, wherein the catalytically active substance is an oxidation catalyst.

13. The device as recited in claim 8, wherein the catalytically active substance is a catalyst that lowers a soot burn-off temperature.

14. The device as recited in claim 8, wherein the catalytically active substance is a material storing at least one of nitrogen oxides and oxygen.

15. The device as recited in claim 3, wherein the porous filter base layer includes a sintered metal.

16. The device as recited in claim 3, wherein the binder is an inorganic material including one of an aluminum oxide, silicon oxide, and aluminosilicate.

17. A method for manufacturing a filter device for filtering particles from exhaust gases of an internal combustion engine, comprising:
providing a porous filter base layer; and
applying a surface layer to a side of the porous filter base layer facing exhaust gases to be filtered, wherein the surface layer includes at least one type of ceramic fibers, and wherein the surface layer is exposed to the exhaust gases, whereby the exhaust gases permeate through the surface layer and the porous filter base layer for filtering.

18. The method as recited in claim 17, wherein the applying of the surface layer includes:
first applying a suspension of the ceramic fibers to the side of the porous filter base layer facing exhaust gases to be filtered;
drawing off excess suspension of the ceramic fibers through the side of the porous filter base layer facing exhaust gases to be filtered; and
heat treating the side of the porous filter base layer coated with the suspension of the ceramic fibers.

19. The method as recited in claim 18, wherein the suspension of the ceramic fibers includes one of: a) a first combination of a first type of ceramic fibers and spherical particles; and b) a second combination of a first type of ceramic fibers and a second type of ceramic fiber, wherein the second type of ceramic fibers having an aspect ratio of 1:1 to 1:5.

20. The method as recited in claim 19, wherein at least one of the first type of ceramic fibers, the second type of ceramic fibers, and the spherical particles are provided with a catalytically active substance before being introduced into the suspension.

21. The method as recited in claim 20, wherein the first type of ceramic fibers are provided with a first catalytically active substance and at least one of the spherical particles and the second type of ceramic fibers are provided with a second catalytically active substance, the first and the second catalytically active substances being distinct.

22. The method as recited in claim 20, wherein the suspension is produced from an alcoholic solution of a hydrolyzable metal alcoholate.
